(19) United States
(12) Patent Application Publication
(10) Pub. No.: US 2010/0208463 A1
(43) Pub. Date: Aug. 19, 2010

(54) LIGHT EMITTING MODULE OF POWER SUPPLY

(76) Inventors: Wen-Ping Chen, Taipei City (TW); I-Chia Lee, Taoyuan County (TW)

Correspondence Address: RABIN & Berdo, PC, 1101 14TH STREET, NW, SUITE 500, WASHINGTON, DC, 20005, US

(21) Appl. No.: 12/370,877

(22) Filed: Feb. 13, 2009

(51) Int. Cl. F21V 7/00

(52) U.S. Cl. 362/260; 362/296.01

(57) ABSTRACT

A light emitting module of a power supply includes a light guide plate disposed on a surface of a casing. A light emitting source such as a light emitting diode or a cathode fluorescent lamp is disposed surrounding the light guide plate. The light emitting source is electrically connected to a power supply module of the power supply. In addition, a decorating sheet is disposed at front of the light guide plate, and is provided with a light transmissive part in form of text or pattern. After being powered on, the power supply drives the light emitting source to emit light, and the light brightens the light guide plate via reflection, and emits from light transmissive part in form of text or pattern, so as to improve the decorative effect of the power supply.

### BACKGROUND OF THE INVENTION

1. Field of the Technology

The present invention relates to a light emitting decorating technique applied to a power supply, and more particularly to a light emitting module construction generating text or pattern emitting light via a decorating sheet after combining a light guide plate with a light emitting source.

2. Background of the Invention

Along with the quick change of the technology, the computer devices such as personal computer and network server have become indispensable in modern life. Because various electronic components, such as motherboard, central processing unit (CPU), and display card or sound card, in the computer devices use 5V-12V DC as a power supply, the common 110V AC should be converted into the required DC by the power supply to be supplied to the electronic components for use.

Currently, a common power supply has a metal casing, and a decorating sheet for indication is disposed on a surface thereof. The attached card shows the power, voltage, and current of the power supply, and various related certification passed, even the trademark of the manufacturer to which the power supply belongs. However, some computer cases employ transparent side plates, the foregoing decorating sheet mostly employ colored printing or foil stamping manner to draw indicating text or trademark etc., and after amounting the power supply into the computer case, it is difficult to improve the decorative or advertising effect effectively by the text or pattern on the surface of the casing of the power supply.

### SUMMARY OF THE INVENTION

An objective of the present invention is providing a light-emitting module construction disposed on a surface of a power supply, which utilizes the light emitting text or pattern to increase the decorative effect when using the power supply.

In order to achieve the objective described above, the present invention mainly includes a light guide plate, a light emitting source, and a decorating sheet. The light guide plate is disposed on the surface of the casing. A plurality of reflecting points is disposed on the back of the light guide plate. The light emitting source is disposed on a proper location around the light guide plate. The light emitting source is a light emitting diode or a cathode fluorescent lamp. The light emitting source is electrically connected to the power supply module of the power supply. A light transmitting part in form of text or pattern is disposed on the decorating sheet, and the decorating sheet is disposed at front of the light guide plate. After the power supply is powered on, the light emitted by the light emitting source passes the light guide plate, and emits from the light transmissive part, so as to generate the light emitting text or pattern on the surface of the power supply. After being powered on, the power supply can drive the light emitting source to emit light, the light brightens the whole light guide plate through reflection, and emits from the light transmissive part in form of text or pattern, thereby improving the decorative effect of the power supply.

### BRIEF DESCRIPTION OF THE DRAWINGS

The present invention will become more fully understood from the detailed description given herein below for illustration only, and thus are not limitative of the present invention, and wherein:

FIG. 1 is a three dimensional exploded view of a preferred embodiment of the present invention.

FIG. 2 is a three dimensional outside view of the preferred embodiment of the present invention.

FIG. 3 is a partial sectional view of the preferred embodiment of the present invention.

### DETAILED DESCRIPTION OF THE EMBODIMENTS

To make the present invention more comprehensible, the present invention is described in detail in the following with reference to the embodiments and accompanying drawings.

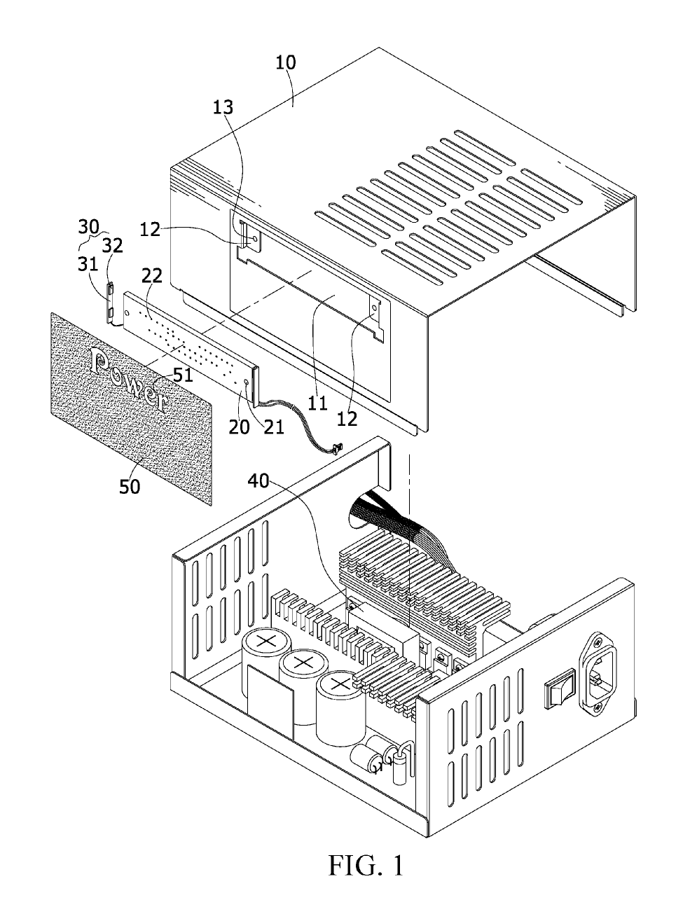

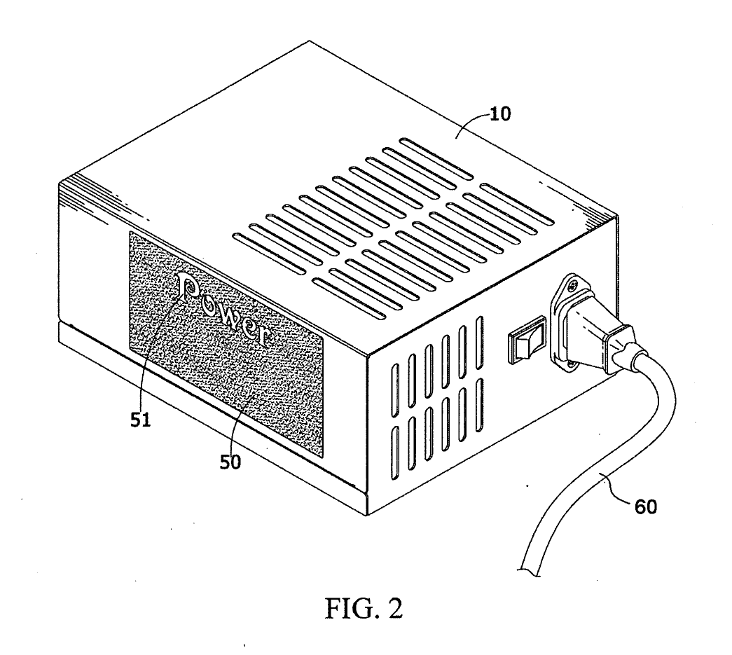

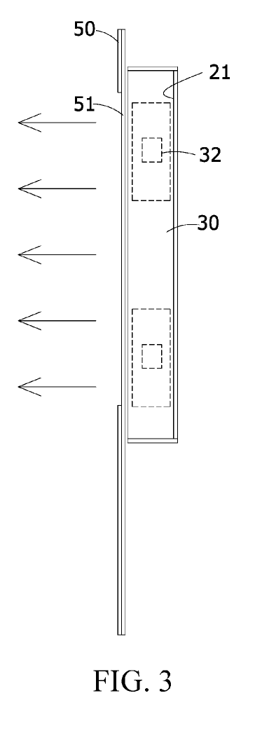

FIGS. 1 to 3 are preferred embodiments of the present invention. Referring to FIGS. 1 to 3, the present invention mainly includes a casing 10, a strip shaped light guide plate 20, at least one light emitting source 30, and a decorating sheet 50.

A rectangle perforation 11 is disposed on a surface of a side of the casing 10. A folded board 12 is disposed at short sides of the perforation 11 and is recessed inwardly, thus forming a pattern similar to a groove, and a mounting hole 13 is disposed at two ends of the folded board 12 respectively.

A mounting hole 21 is disposed at two sides of the strip shaped light guide plate 20 respectively to be fixed on the folded board 12 of the casing 10, so that after being disposed at the perforation 11, the light guide plate 20 forms a plane with the casing 10. A plurality of reflecting structures 22, such as, reflecting points, reflecting strips, or a reflecting surface, is distributed at the back of the light guide plate 20.

In the drawing, two light emitting diodes 32 are disposed on each of the two circuit boards 31 respectively, and the present invention uses the high brightness light emitting diodes 32. The light emitting diodes 32 are disposed at two side edges of the light guide plate 22 in alignment, and the circuit board 31 of the light emitting source 30 is electrically connected to the power supply module 40 of the power supply. Further, the light emitting source 30 may be a cathode fluorescent lamp with a flexible forming to surround the light guide plate 20. By the reflecting structures 22 at the back of the light guide plate 20, the light emitted by the light emitting source 30 can irradiate into the light guide plate 22 and brighten the whole light guide plate 22 after being reflected by the reflecting structures 22, which provides an effect similar to backlight.

The decorating sheet 50 wraps the surface of the light guide plate 20 completely, and is locally attached to the surface of the casing 10. A light transmissive part 51 in the form of text or pattern is disposed on the decorating sheet 50, so that the light emitted by the light emitting source 30 passes through the light transmissive part 51, and the decorative effect of only the light transmissive part 51 being alight is realized.

In use, the power line 60 is connected to the power supply, and a switch is activated to power on the power supply. The power supply module 40 of the power supply can actuate the light emitting source 30 to emit light and brighten the whole piece of light guide plate 20, and the light transmissive part 51 of the light transmissive decorative plate 50 may have the decorative effect of the light emitting text or light emitting pattern. Furthermore, when the power supply is normally operating, the light emitting source 20 thereof can be kept in a normal lighting state, and if the power supply module 40 of the power supply is failed, the light emitting source 30 also goes out accordingly, therefore achieving the effect of caution.

As described above, as shown in FIGS. 1-3, the present invention has the following advantages.

1. The present invention utilizes the power supply module 40 to drive the light emitting source 30 to emit light to brighten the light guide plate 20, and the light of the light guide plate 20 passes through the light transmissive part 51 of the decorating sheet 50, thereby realizing the decorative effect such as light emitting pattern or light emitting text.

2. Furthermore, a caution unit 32 is disposed at the power supply module 40 of the present invention, and when the power supply is abnormal, the light of the light emitting source 30 also goes out accordingly, so as to prompt the user to replace.

3. The light transmissive part 51 of the decorating sheet 50 of the present invention may change to forms such as pattern or text according to the requirements of the users or manufacturers, thus further improving the effect of decoration.

The description above is only the preferred embodiments of the present invention, instead of limiting the scope of the embodiments of the present invention. The selection of the light emitting source and the manner of converting the form of the light transmissive part of the decorating sheet and so on are also in the scope of the present invention. Therefore, the equivalent or simple variations made by those skilled in the art, such as changing the light transmissive part in the form of text into the light transmissive part in the form of pattern, all should be covered in the claims of the present invention without departing from the spirit and range of the present invention.

Accordingly, the light emitting module of the power supply of the present invention has creative steps and industrial value in use, so the applicant files a utility model patent according to the patent law.

1. A light emitting module of a power supply, electrically connected to a power supply module, at least comprising:
a casing, wherein a perforation is disposed on a surface thereof;
a light guide plate disposed in the perforation of the casing, wherein a reflecting structure is disposed at a back of the light guide plate;
a light emitting source disposed in the surrounding of the light guide plate, wherein the light emitting source is electrically connected to the power supply module, and after the light emitting source is activated and lit, the light is reflected by the reflecting structure in the light guide plate, so as to brighten the whole light guide plate, the light emitting source being dark during failure of the power supply module to create a caution effect; and
a decorating sheet completely covering a surface of the light guide plate, comprising a light transmissive part disposed therein, so that the light emitted by the light emitting source passes through the light transmissive part to generate a light emitting decorative effect such that the decorative effect is of only the light transmissive part being illuminated.

2. The light emitting module of the power supply according to claim 1, wherein a folded board is disposed at two end edges of the perforation respectively, and at least one fixing hole is disposed on each folded board.

3. The light emitting module of the power supply according to claim 1, wherein the reflecting structure is a plurality of reflecting points.

4. The light emitting module of the power supply according to claim 1, wherein the reflecting structure is a plurality of reflecting strips.

5. The light emitting module of the power supply according to claim 1, wherein the reflecting structure is a reflecting surface.

6. The light emitting module of the power supply according to claim 1, wherein the light emitting source is a light emitting diode.

7. The light emitting module of the power supply according to claim 1, wherein the light emitting source is a cathode fluorescent lamp.

8. The light emitting module of the power supply according to claim 1, wherein the light transmissive part of the decorating sheet is in the form of pattern.

9. The light emitting module of the power supply according to claim 1, wherein the light transmissive part of the decorating sheet is in the form of text.

10. The light emitting module of the power supply according to claim 1, wherein the light transmissive part has a smaller area than the decorating sheet, so that when the light transmissive part is illuminated, a portion of the decorating sheet remains non-illuminated.
